(19) United States
(12) Patent Application Publication
(10) Pub. No.: US 2026/0024945 A1
(43) Pub. Date: Jan. 22, 2026

(54) LEVER CONNECTOR MANUAL LOCK

(71) Applicant: IDEAL Industries, Inc., Sycamore, IL (US)

(72) Inventors: Douglas Albert Sanford, Littleton, CO (US); Jason W. Ludewig, Rockford, IL (US); Alan Emad Zantout, Sycamore, IL (US)

(21) Appl. No.: 19/272,455

(22) Filed: Jul. 17, 2025

Related U.S. Application Data
(60) Provisional application No. 63/672,444, filed on Jul. 17, 2024.

(51) Int. Cl. H01R 13/629

(52) U.S. Cl. CPC H01R 13/62933

(57) ABSTRACT

A lever connector includes a connector body, pivotable levers movable between open and closed positions to actuate clamping sites for securing conductors, and a lock member that is movably coupled to the connector body and configured to transition between a locked position, preventing lever actuation, and an unlocked position, permitting lever actuation. The lock member may slide or rotate relative to the connector body.

### CROSS-REFERENCE TO RELATED APPLICATION

This application claims the benefit of priority to U.S. provisional application No. 63/672,444, filed on Jul. 17, 2024, which application is hereby incorporated by reference in its entirety.

### FIELD OF THE DISCLOSURE

The present disclosure generally relates to lever connectors, including manual locking features for lever connectors.

### BACKGROUND

Lever connectors may be utilized for tool-free electrical splicing in residential, commercial, and industrial wiring installations. While alternative connector types such as twist-on, crimp, and push-in devices are available, lever connectors are generally known to offer reusability, rapid installation, and clear visual confirmation of conductor engagement.

### BRIEF DESCRIPTION OF THE DRAWINGS

FIG. 1A is a perspective view of an example locking lever connector in a closed and locked state.

FIG. 1B is a perspective view of the example locking lever connector of FIG. 1A, in a closed and unlocked state.

FIG. 1C is a perspective view of the example locking lever connector of FIG. 1A, in an open and unlocked state.

FIG. 2A is an exploded view of the example locking lever connector of FIG. 1A.

FIG. 2B is an exploded view of the example locking lever connector of FIG. 1A.

FIG. 3 is a cross-sectional view of a portion of the example locking lever connector of FIG. 1A.

FIG. 4A is a perspective view of the example locking lever connector of FIG. 1A, in a closed and locked state, with a body of the locking lever connector illustrated as transparent.

FIG. 4B is a perspective view of the example locking lever connector of FIG. 1A, in an open and unlocked state, with a body of the locking lever connector illustrated as transparent.

FIG. 5A is a perspective view of an example locking lever connector in a closed and locked state.

FIG. 5B is a perspective view of the example locking lever connector of FIG. 5A, in a closed and unlocked state.

FIG. 5C is a perspective view of the example locking lever connector of FIG. 5A, in an open and unlocked state.

FIG. 6A is an exploded view of the example locking lever connector of FIG. 5A.

FIG. 6B is an exploded view of the example locking lever connector of FIG. 5A.

FIG. 7 is a cross-sectional view of a portion of the example locking lever connector of FIG. 5A.

FIG. 8A is a perspective view of the example locking lever connector of FIG. 5A, in a closed and locked state, with a body of the locking lever connector illustrated as transparent.

FIG. 8B is a perspective view of the example locking lever connector of FIG. 5A, in an open and unlocked state, with a body of the locking lever connector illustrated as transparent.

FIG. 9A is a perspective view of an example locking lever connector in a closed and locked state.

FIG. 9B is a perspective view of the example locking lever connector of FIG. 9A, in a closed and unlocked state.

FIG. 9C is a perspective view of the example locking lever connector of FIG. 9A, in an open and unlocked state.

FIG. 10 is a cross-sectional view of a portion of the example locking lever connector of FIG. 9A.

FIG. 11 is an exploded view of the example locking lever connector of FIG. 9A.

FIG. 12A is a perspective view of an example locking lever connector in a closed and locked state.

FIG. 12B is a perspective view of the example locking lever connector of FIG. 12A, in a closed and unlocked state.

FIG. 12C is a perspective view of the example locking lever connector of FIG. 12A, in an open and unlocked state.

FIG. 13 is a cross-sectional view of a portion of the example locking lever connector of FIG. 12A.

FIG. 14 is an exploded view of the example locking lever connector of FIG. 12A.

FIG. 15 is a perspective view of the example locking lever connector of FIG. 12A, in a closed and locked state, with a body of the locking lever connector illustrated as transparent.

FIG. 16A is a perspective view of an example locking lever connector in a closed and locked state.

FIG. 16B is a perspective view of the example locking lever connector of FIG. 16A, in a closed and unlocked state.

FIG. 16C is a perspective view of the example locking lever connector of FIG. 16A, in an open and unlocked state.

FIG. 17 is a cross-sectional view of a portion of the example locking lever connector of FIG. 16A.

FIG. 18 is an exploded view of the example locking lever connector of FIG. 16A.

FIG. 19 is a perspective view of the example locking lever connector of FIG. 16A, in a closed and locked state, with a body of the locking lever connector illustrated as transparent.

FIG. 20A is a perspective view of an example locking lever connector in a closed and locked state.

FIG. 20B is a perspective view of the example locking lever connector of FIG. 20A, in a closed and unlocked state.

FIG. 20C is a perspective view of the example locking lever connector of FIG. 20A, in an open and unlocked state.

FIG. 21 is a cross-sectional view of a portion of the example locking lever connector of FIG. 20A.

FIG. 22 is an exploded view of the example locking lever connector of FIG. 20A.

FIG. 23 is a perspective view of the example locking lever connector of FIG. 20A, in a closed and locked state, with a body of the locking lever connector illustrated as transparent.

FIG. 24A is a perspective view of an example locking lever connector in a closed and locked state.

FIG. 24B is a perspective view of the example locking lever connector of FIG. 24A, in a closed and unlocked state.

FIG. 24C is a perspective view of the example locking lever connector of FIG. 24A, in an open and unlocked state.

FIG. 25 is a cross-sectional view of a portion of the example locking lever connector of FIG. 24A.

FIG. 26 is an exploded view of the example locking lever connector of FIG. 25A.

FIG. 27 is a perspective view of the example locking lever connector of FIG. 25A, in a closed and locked state, with a body of the locking lever connector illustrated as transparent.

FIG. 28A is a perspective view of an example locking lever connector in a closed and locked state.

FIG. 28B is a perspective view of the example locking lever connector of FIG. 28A, in a closed and unlocked state.

FIG. 28C is a perspective view of the example locking lever connector of FIG. 28A, in an open and unlocked state.

FIG. 29 is an exploded view of the example locking lever connector of FIG. 28A.

FIG. 30 is a cross-sectional view of a portion of the example locking lever connector of FIG. 28A.

FIG. 31 is a cross-sectional view of a portion of the example locking lever connector of FIG. 28B.

FIG. 32 is a perspective view of two spring members.

FIG. 33A is a perspective view of an example locking lever connector in a closed and unlocked state.

FIG. 33B is a perspective view of the example locking lever connector of FIG. 33A, in an open and unlocked state.

FIG. 33C is a perspective view of the example locking lever connector of FIG. 33A, in a closed and locked state.

FIG. 34 is a cross-sectional view of the example locking lever connector of FIG. 33A.

### DETAILED DESCRIPTION

Lever connectors are commonly used to electrically couple multiple electrical conductors (e.g., wires) together. In such a connector, two or more conductor insertion ports are provided, each leading to a clamping site. Each clamping site may be opened and closed using a respective lever than is manually actuatable by a user. Known lever connectors generally do not permanently secure levers against accidental opening and closing. For example, a lever may get caught on a corner, wire, or other environmental body and be accidentally opened, thereby disturbing the electrical connection that the lever connector is intended to provide. Accordingly, the instant disclosure provides locking features and mechanisms for securing levers against accidental manipulation.

The instant disclosure includes various lock member forms and mechanisms by which a lock member can mechanically prevent the levers of a lever connector from being actuated inadvertently so as to open clamping connections unintentionally.

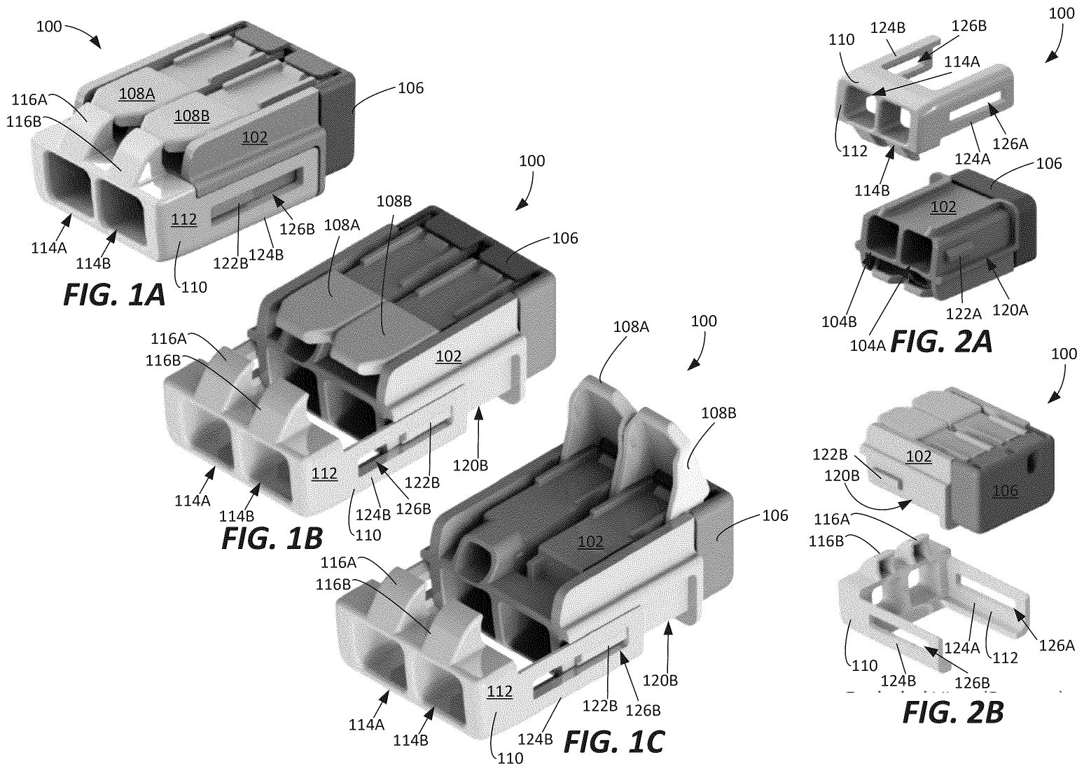

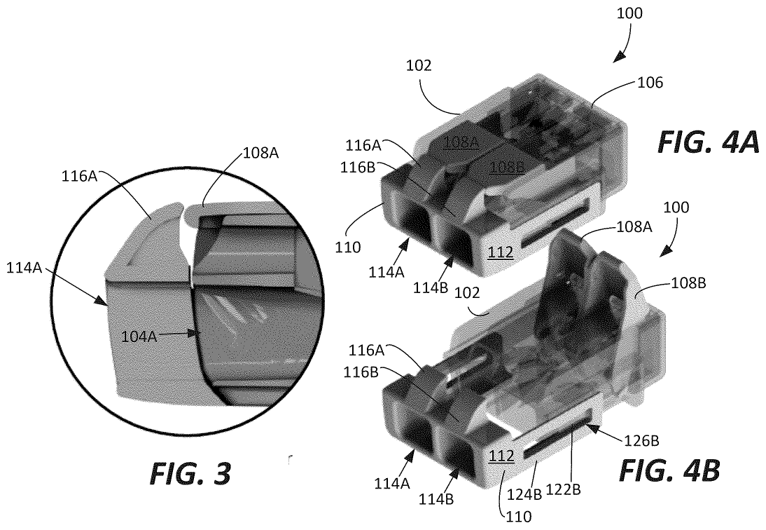

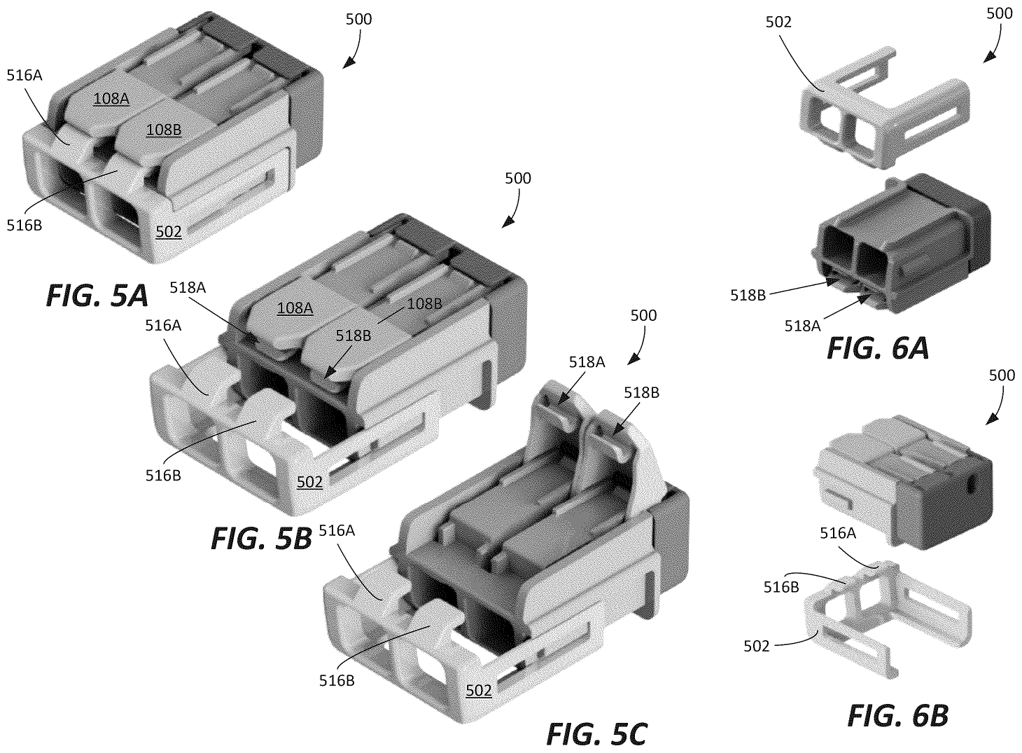

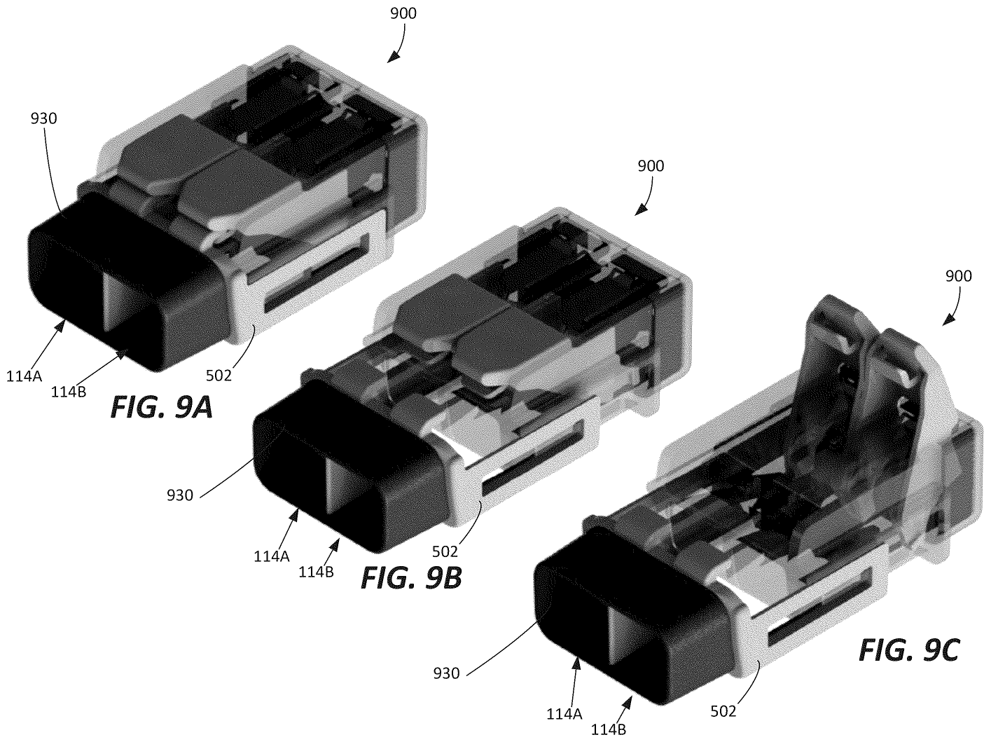

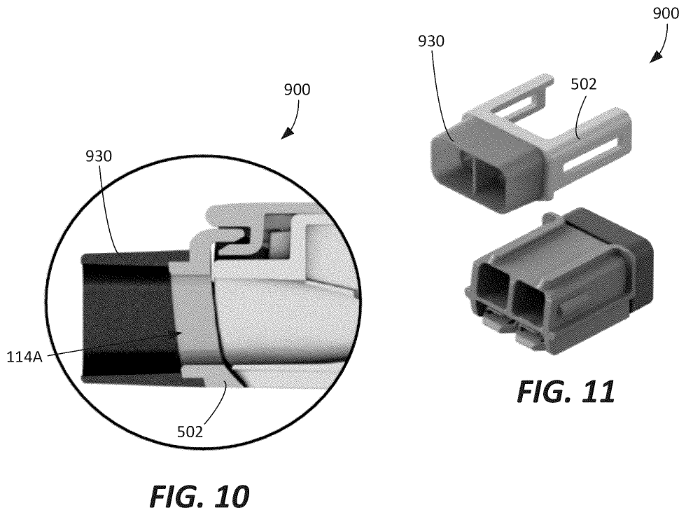

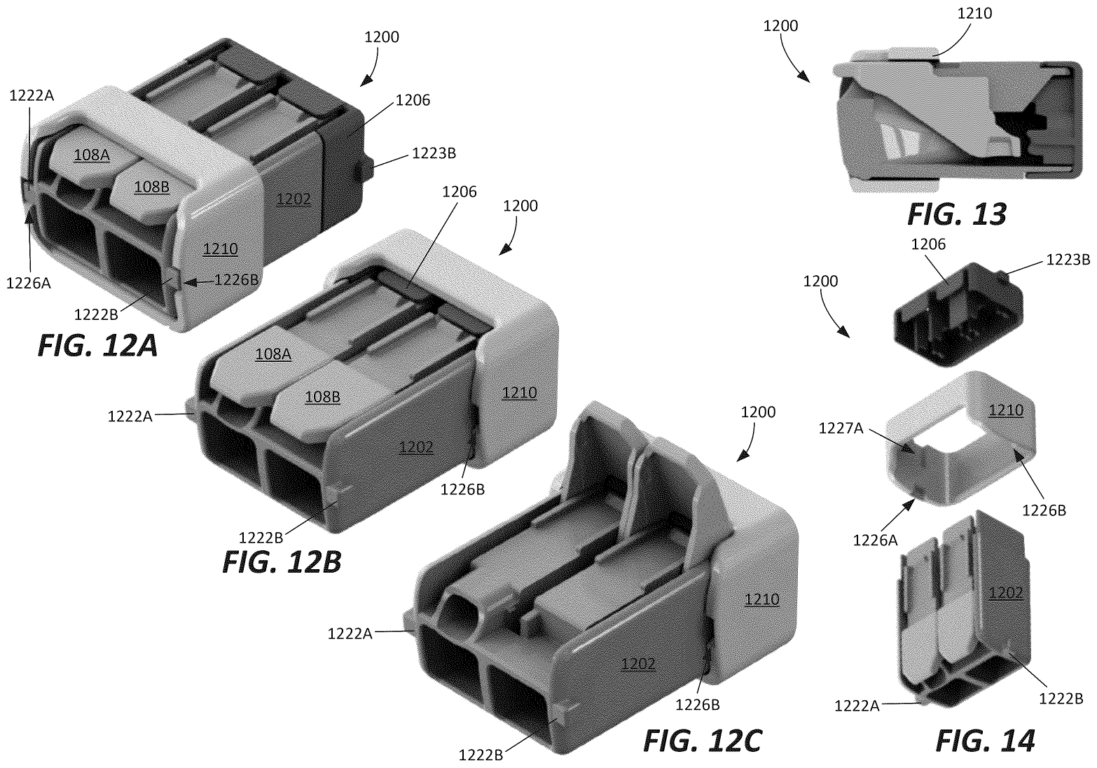

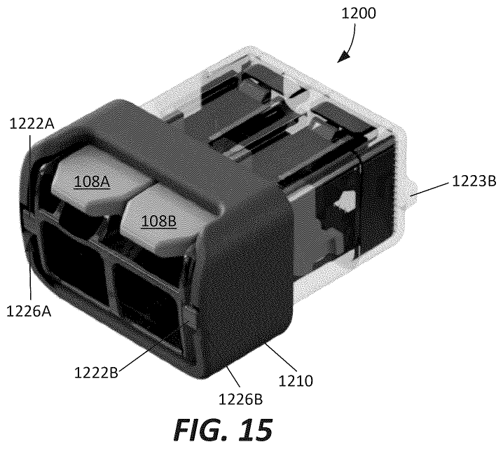

For example, in various embodiments, including the lever connector 100 (FIGS. 1A-4B), lever connector 500 (FIGS. 5A-8B), the lever connector 900 (FIGS. 9A-11), and the lever connector 1200 (FIGS. 12A-15), the lock member is configured to slide relative to the connector body between a locked position and an unlocked position. In these embodiments, the lock member is retained on the connector body by engagement with corresponding recesses, protrusions, or arms, and is slidable along a longitudinal axis generally parallel to the conductor insertion direction. When the lock member is in the locked position, it prevents actuation of the levers by physically obstructing access or movement, such as by overlapping with end portions of the levers or engaging with receiving formations. When the lock member is slid to the unlocked position, the levers are accessible and movable and may be moved between open and closed positions to actuate the clamping sites. This sliding lock configuration provides a secure and user-friendly mechanism for selectively locking and unlocking the levers, and may be implemented in a variety of forms as illustrated in the referenced embodiments.

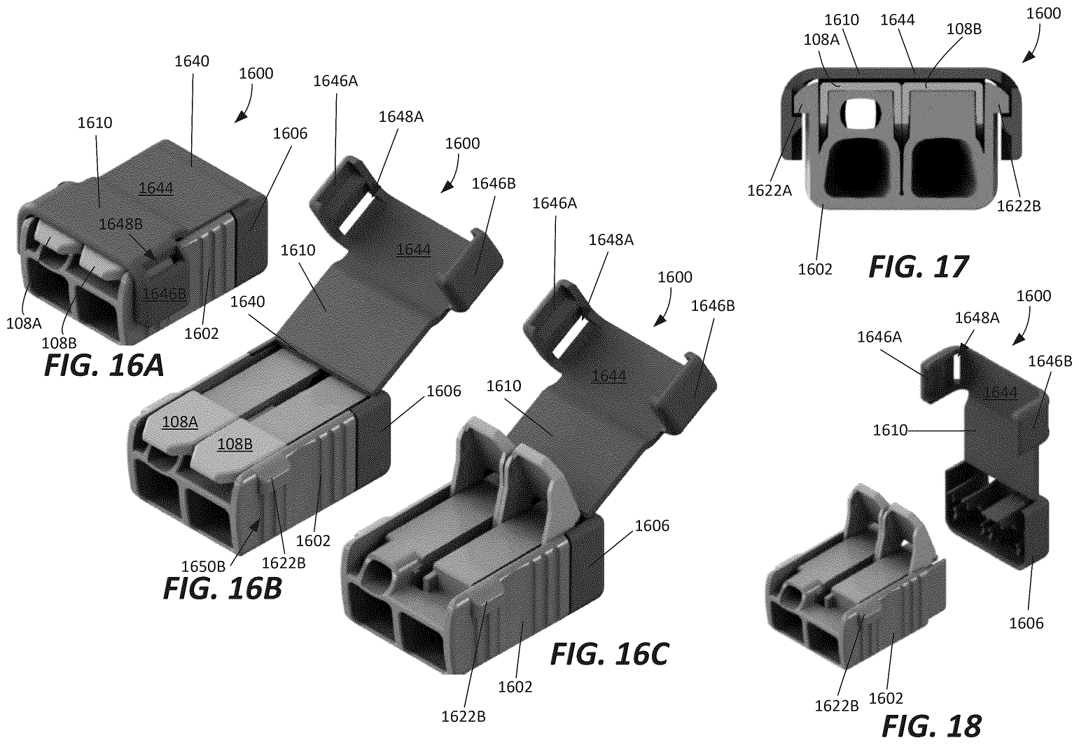

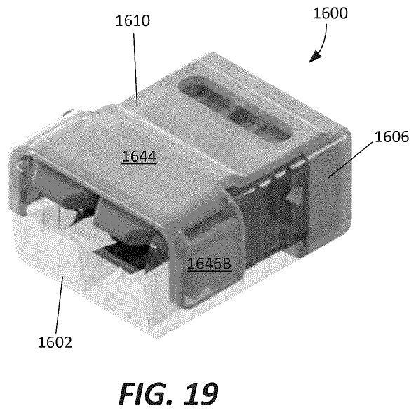

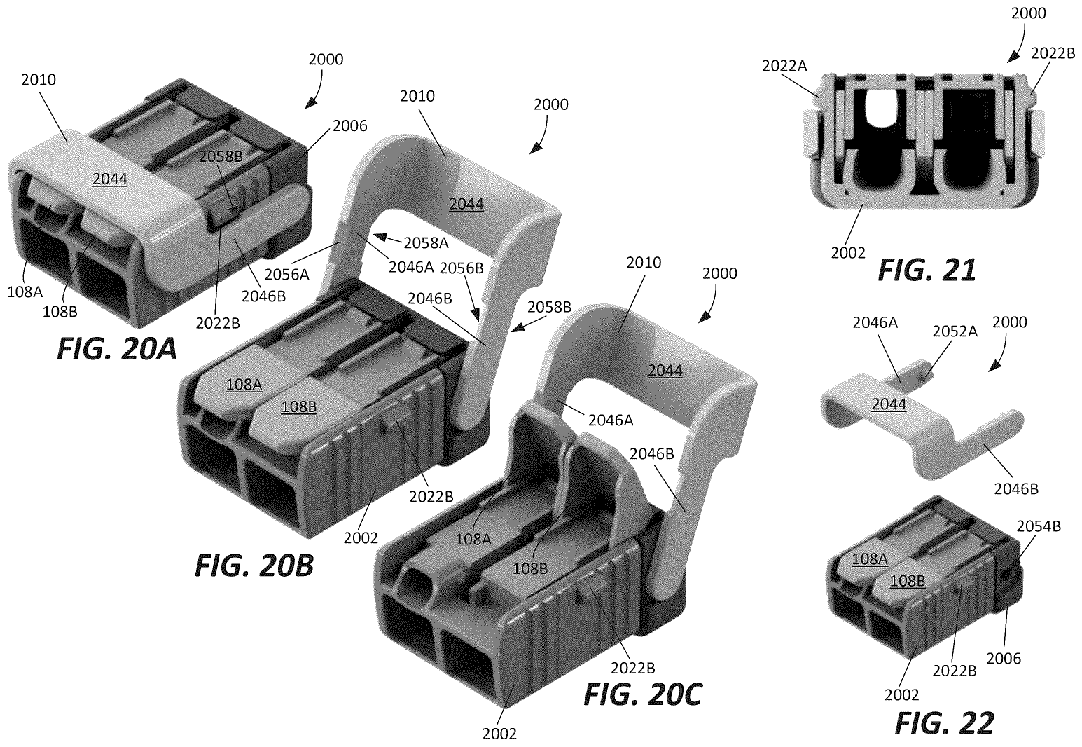

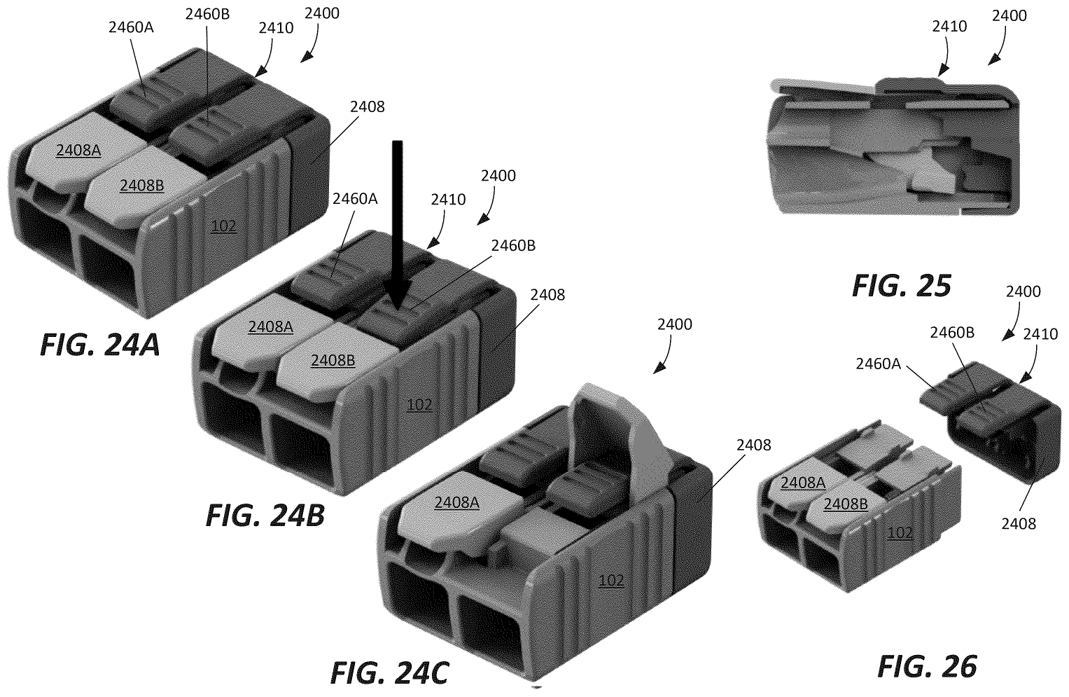

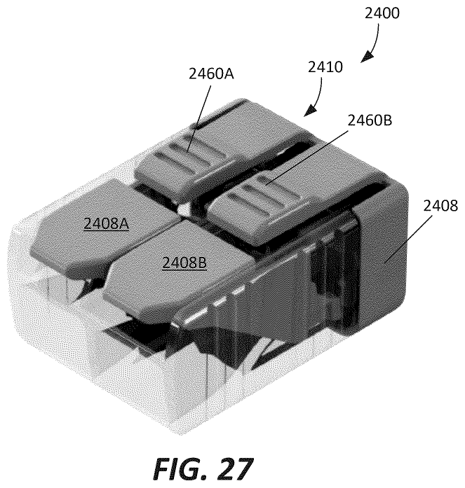

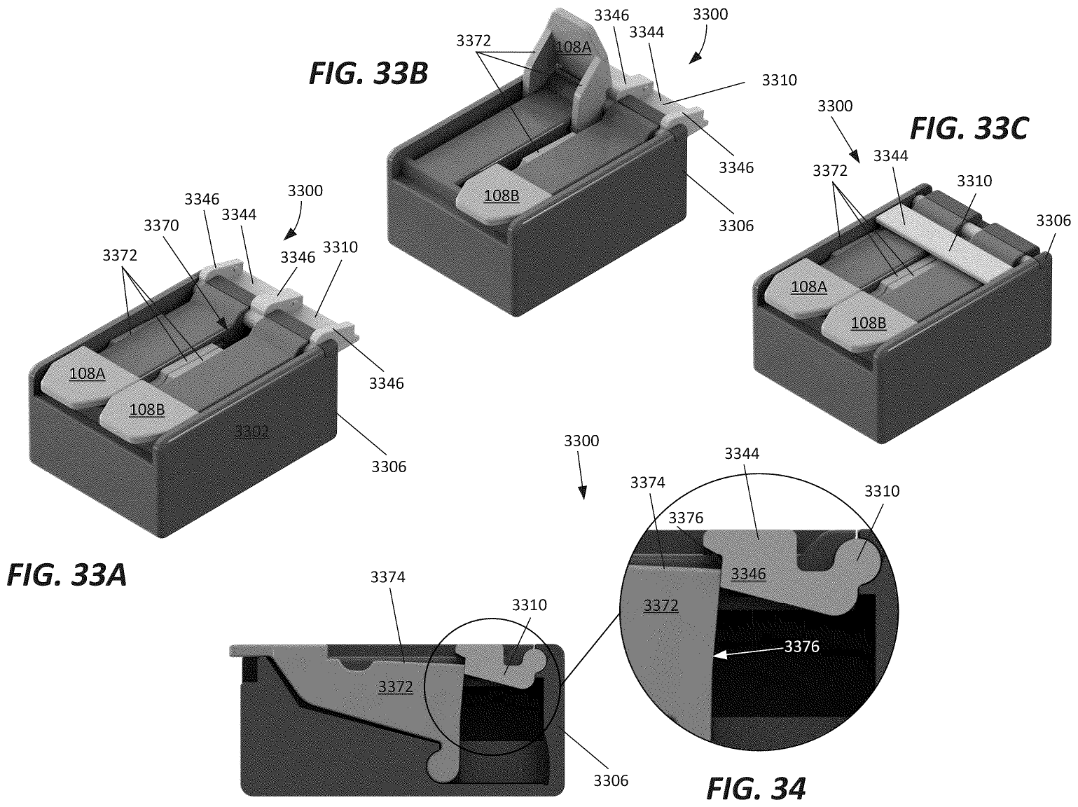

In another example, in certain embodiments, including the lever connector 1600 (FIGS. 16A-19), the lever connector 2000 (FIGS. 20A-23), the lever connector 2400 (FIGS. 24A-27), and the lever connector 3300 (FIGS. 33A-34), the lock member is configured to rotate relative to the connector body between a locked position and an unlocked position. In these embodiments, the lock member is pivotally or hingedly coupled to the connector body, such as by a living hinge, a pin-and-aperture arrangement, or an integral flexible connection. When the lock member is in the locked position, it physically obstructs or restrains the levers, preventing their movement and thereby securing the clamping sites. Rotation of the lock member to the unlocked position removes this obstruction, permitting the levers to be actuated between open and closed positions. This rotational locking mechanism provides a robust and intuitive means for selectively locking and unlocking the levers, and may be implemented in various forms as illustrated in the referenced embodiments.

FIGS. 1A-4B illustrate an example locking lever connector 100 that includes a body portion 102 defining two conductor insertion openings 104A, 104B permitting access to two clamping sites, a cap 106 disposed at the back of the body 102, and two levers 108A, 108B disposed on the body 102 for opening and closing the two clamping sites. The lever connector 100 further includes a lock member 110 that may be overlaid on the front side of the connector 100—that is, the side of the body portion 102 in which the conductor insertion openings 104A, 104B are defined.

The lock member 110 may include a lock body 112 defining two conductor insertion openings 114A, 114B that may align with the conductor insertion openings 104A, 104B of the connector body portion 102. The lock member 110 may further include two wedge portions 116A, 116B that align with the two levers 108A, 108B. In particular when the lock member 110 is in a locked position (shown in FIGS. 1A, 3, and 4A), each wedge portion 116 may vertically overlap with the entirety of the height of the end of the lever 108, and may longitudinally overlap with at least some portion of the end of the lever 108, thereby preventing access to the lever 108 and effectively locking the lever 108.

The connector body 102 may define longitudinally-extending recesses 120A, 120B in the lateral faces of the body 102, with inlaid protrusions 122A, 122B in the lateral recesses 120A, 120B. The lock member may include longitudinally-extending arms 124A, 124B that may be seated in the recesses of the connector body. Each arm may define a longitudinal aperture 126A, 126B that fits over the inlaid protrusion 122A, 122B of the connector body recess 120A, 120B, and thus the lock member 110 may slide along the lateral sides of the connector body 102. In operation, the longitudinal length of the aperture 126A, 126B may, via engagement with the protrusion 122A, 122B, limit and define the range of longitudinal movement of the lock member 110, as well as coupling the connector body 102 with the lock member 110.

In operation, the lock member 110 may be initially coupled to the connector body 102 by flexing the arms 124 outward, placing the arm apertures 126 over the protrusions 122, and allowing the arms 124 to elastically return to their parallel position. The connector 100 may be locked by sliding the lock member 110 rearward towards the connector body 102 (to the position in FIG. 1A), and unlocked by sliding the lock member 110 forward and away from the connector body 102 (to the position in FIG. 1B).

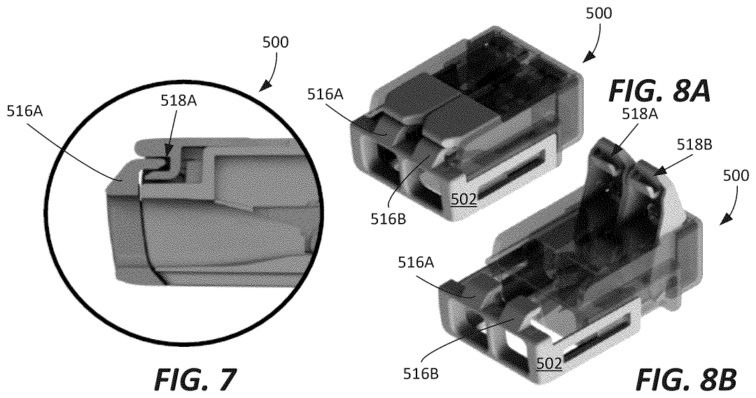

FIGS. 5A-8B illustrate an example locking lever connector 500 that includes similar features to the connector 100 except as described below. The connector 500 includes a lock member 502 with partial wedges 516A, 516B that interact with receiving formations 518A, 518B (e.g., apertures) defined in the levers 108A, 108B. For example, referring to FIG. 7, each receiving formation 518 may be or may include a hook under the top surface of the lever 108, and the partial wedge 516 may insert into the hook when the lock member 502 is in the closed position, thereby preventing upward movement of the lever 108.

FIGS. 9A-11 illustrate an example locking lever connector 900 that includes similar features to the connector 500 except as described below. Connector 900 includes an overmold 930. The overmold 930 may be coupled to a front of the lock member 502, around the conductor insertion openings 114A, 114B, and may, in effect, longitudinally extend the insulative portion of the conductor insertion openings 114A, 114B, thereby helping to prevent flashover.

FIGS. 12A-15 illustrate an example locking lever connector 1200 that includes similar features to the connector 100 except as described below. The lever connector 1200 may include a lock member 1210 in the form of a collar that extends laterally around the entirety of the connector body 1202. The lock member 1210 may slide longitudinally over and along the body (e.g., over and along the top, bottom, and lateral sides) such that, when the lock member 1210 is positioned at the front of the body 1202 (as shown in FIG. 12A), all levers 108A, 108B are locked and, when the lock member 1210 is positioned at the back of the body 1202 (as shown in FIGS. 12B and 12C), all levers 108A, 108B are unlocked.

The lock member 1210 may define longitudinal recesses 1226A, 1226B, 1227A, 1227B in an inner lateral surface. For example, the lock member may include a first pair of recesses 1226A, 1226B in a front of the lock member, and a second pair of recesses 1227A, 1227B (though not shown, recess 1227B may mirror recess 1227A and be provided in the opposing inner surface) in a back of the lock member 1202. Each recess 1226A, 1226B, 1227A, 1227B may have a stop surface. The connector body 1202 may include two front protrusions 1222A, 1222B on an outer surface at a front of the connector body, and the cap 1206 may include two rear protrusions 1223A, 1223B. The front protrusions 1222A, 1222B may interact with the first pair of recesses 1226A, 1226B, and the rear protrusions 1223A, 1223B may interact with the second pair of recesses 1227A, 1227B. Specifically, the first pair of recesses 1226A, 1226B may slide over the front protrusions 1222A, 1222B until the stop surfaces of the first pair of recesses 1226A, 1226B reach the front protrusions 1222A, 1222B. Contact of the stop surfaces of the first pair of recesses 1226A, 1226B with the front protrusions 1222A, 1222B may limit forward movement of the lock member 1202. Similarly, the second pair of recesses 1227A, 1227B may slide over the rear protrusions 1223A, 1223B until the stop surfaces of the second pair of recesses 1227A, 1227B reach the rear protrusions 1223A, 1223B, and contact of the stop surfaces of the second pair of recesses 1227A, 1227B with the rear protrusions 1223A, 1223B may limit rearward movement of the lock member 1202.

FIGS. 16A-19 illustrate an example locking lever connector 1600 that includes similar features to the connector 100 except as described below. The lever connector 1600 includes a lock member 1610 in the form of a hinged cover with a living hinge. In the connector 1600, the lock member 1610 is formed as a unitary piece with the cap 1606. In some embodiments, the lock member 1610 and the cap 1606 may be formed from a monolithic body of material, with the lock member 1610 coupled to and separated from the cap 1606 by a living hinge 1640 formed in the monolithic body of material.

The lock member 1610 may include a cover surface 1644 extending longitudinally from the living hinge 1640. The cover surface 1644 may have substantially the same width and length as the connector body 1602, in some embodiments, such that the cover surface 1644 overlays substantially all of the top of the connector body 1602 and the levers 108A, 108B when the lock member 1610 is closed.

The lock member 1610 may further include lateral extension members 1646A, 1646B (e.g., wings) that extend downward over the lateral sides of the connector body 1602 when the lock member 1610 is in the locked position (FIGS. 16A, 17, 19). Each extension member 1646A, 1646B may define an aperture 1648A, 1648B or recess and one or more longitudinal stop surfaces. The connector body 1602 may include, on each lateral side, a lateral protrusion 1622A, 1622B positioned to interface with the aperture on the corresponding extension member. The connector body 1602 may further include, on each lateral side, one or more vertical protrusions 1650A, 1650B positioned to interface with the longitudinal stop surfaces of the extension members 1646A, 1646B.

With the lock member 1602 unlocked (FIGS. 16B and 16C), the levers 108A, 108B may be moved between the closed position (FIG. 16B) and the open position (FIG. 16C). The lock member 1602 may be moved to the locked position by rotating the cover surface 1644 about the living hinge 1640 (e.g., about the axis of the living hinge 1640, which may be laterally-extending, perpendicular to the conductor insertion direction, and generally parallel with an axis of rotation of the levers 108A, 108B) until the cover surface 1644 lays on the upper surface of the connector body 1602. The lock member 1610 may be locked by extending the lateral extension members 1646A, 1646B over the lateral sides of the connector body 1602 until the lateral protrusions 1622A, 1622B extend into the apertures 1648A, 1648B in the lateral extension members 1646A, 1646B, with the stop surfaces positioned against the vertical protrusions 1650A, 1650B. When locked, the coupling of the lateral protrusions 1622A, 1622B with the extension member apertures 1648A, 1648B may impede opening of the lock member 1610, and interaction of the stop surfaces with the vertical protrusions 1650A, 1650B may further inhibit movement of the lock member 1610 along the conductor insertion direction. When locked, the lock member 1610 may prevent access to and lock in position all levers 108A, 108B.

FIGS. 20A-23 illustrate an example locking lever connector 2000 that includes similar features to the connector 100 except as described below. The lever connector 2000 includes a lock member 2010 in the form of a rotating lateral lock bar. The lock member 2010 may include a lateral bar 2044 that extends across the entire width of the connector body 2002, and across the levers 108A, 108B, when in the locked position (FIG. 20A). The lateral bar 2044 may extend between longitudinal arms 2046A, 2046B that extend longitudinally (that is, along the conductor insertion direction) along the lateral sides of the connector body 2002 when in the locked position. The longitudinal arms 2046A, 2046B may extend to the cap 2006, and the longitudinal arms 2046A, 2046B may be hingedly coupled with the cap 2006, such that the lock member 2010 rotates about a rotation axis that extends laterally through the cap 2006.

The longitudinal arms 2046A, 2046B may include inward protrusions 2052A, 2052B at an end portion, and the cap 2006 may define lateral recesses 2054A, 2054B configured to mate with the inward protrusions 2052A, 2052B. The protrusions 2052A, 2052B and lateral recesses 2054A, 2054B may both be circular, such that the inward protrusions 2052A, 2052B may rotate in the recesses 2054A, 2054B. The rotation axis of the lock member 2010 may be defined by and extend through a radial center of the protrusions 2052A, 2052B and the recesses 2054A, 2054B. The rotation axis of the lock member 2010 may be generally parallel with an axis of rotation of the levers and generally perpendicular to the conductor insertion direction.

The connector body 2002 may include lateral protrusions 2022A, 2022B on the lateral sides of the body 2002. As shown in FIG. 20A, with the locking member 2010 in the locked position, the lateral protrusions 2022A, 2022B may extend further outward laterally than the longitudinal arms 2046A, 2046B and may be disposed above the longitudinal arms 2046A, 2046B, such that the lateral protrusions 2052A, 2052B impede rotation of the locking member 2010 out of the locked position. Each longitudinal arm 2046A, 2046B may include a chamfered or ramped edge portion 2056A, 2056B on its lower edge, aligned with the lateral protrusions 2022A, 2022B, to enable the longitudinal arms 2046A, 2046B to pass downward over the lateral protrusions 2022A, 2022B more easily. Similarly, each lateral protrusion 2022A, 2022B may include a chamfered or ramped edge on its upper edge, to enable the longitudinal arms 2046A, 2046B to pass downward over the lateral protrusions 2022A, 2022B more easily.

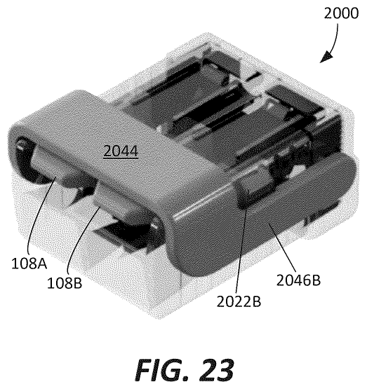

With the lock member 2010 unlocked (FIGS. 20B and 20C), the levers 108A, 108B may be moved between the closed position (FIG. 20B) and the open position (FIG. 20C). The lock member 2010 may be moved to the locked position by rotating the lateral bar 2044 downward until the chamfered edge portions 2056A, 2056B of the longitudinal arms 2046A, 2046B meet the lateral protrusions 2022A, 2022B. Given sufficient downward force, the longitudinal arms 2046A, 2046B will flex to allow passage over the lateral protrusions 2022A, 2022B, and for the lateral bar 2044 to meet the upper surface of the levers 108A, 108B and the connector body 2002, as shown in FIGS. 20A and 23. When locked, the lateral bar 2044 prevents upward movement of both levers 108A, 108B.

FIGS. 24A-27 illustrate an example locking lever connector 2400 that includes similar features to the connector 100 except as described below. The connector 2400 includes a lock member 2410 in the form of a plurality of lock buttons 2460A, 2460B, e.g., a respective lock button 2460 (e.g., spring tab) associated with each lever 2408A, 2408B. The lock buttons 2460A, 2460B may be unitary with the cap 2408. In some embodiments, the lock buttons 2460A, 2460B may be formed of a monolithic body of material with the cap 2408.

Each lock button 2460A, 2460B may extend longitudinally to, or over, the rear longitudinal edge of its associated lever 2408A, 2408B. Accordingly, when in the locked position (FIG. 24A), the lock button 2460A, 2460B may prevent upward motion of the lever 2408A, 2408B by impeding movement of the rear side of the lever surface.

Each lock button 2460A, 2460B may include a tab that extends longitudinally forward from the cap, and which may flex up and down independent of the other lock buttons. Accordingly, in order to unlock a given lock button 2460A, 2460B and its associated lever 2408A, 2408B, the tab may be pressed downward (illustrated with a downward arrow in FIG. 24B) as the lever 2408A, 2408B is lifted over the tab, at which point the lever 2408A, 2408B may freely open and the tab may be released to return to the position shown in FIG. 24C. Because the tabs may be independently depressed and released, the levers 2408A, 2408B may be individually locked and unlocked in the connector 2400.

The lock buttons 2460 may rotate with respect to the connector body 102 (and, after rotation, may extend into the connector body 102) in response to user downward pressure and may elastically return upward to the locked position upon release of user pressure.

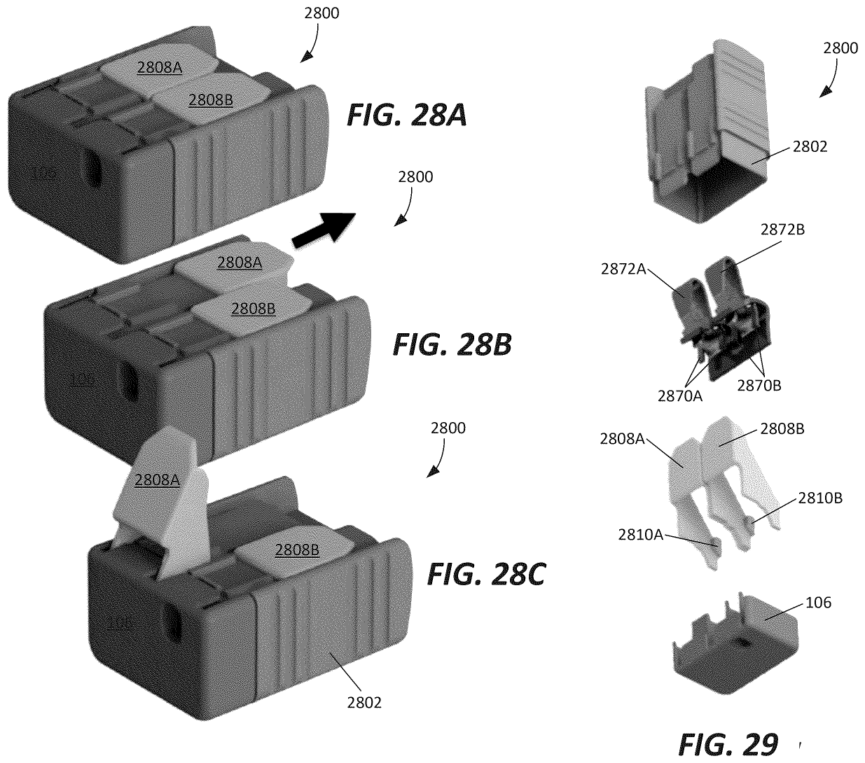

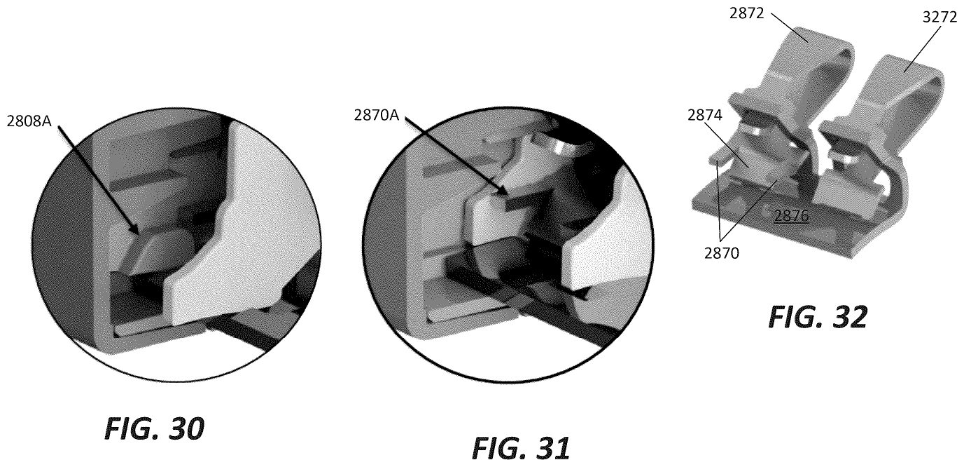

FIGS. 28A-31 illustrate an example locking lever connector 2800 that includes similar features to the connector 100 except as described below. The lever connector 2800 includes, on each lever 2808A, 2808B, a respective lock member 2810A, 2810B in the form of an inward protrusion or nib on the lever 2808A, 2808B, within the connector body 2802, in conjunction with arm portions 2870A, 2870B on each spring 2872A, 2872B. The lever 2808A, 2808B may slide longitudinally between an unlocked position (FIGS. 28B (first lever 2808A), 31), in which the nibs 2810A, 2810B apply force to the spring arms 2870A, 2870B when the lever 2808A, 2808B is rotated, and a locked position (FIGS. 28A (both levers), 28B (second lever 2808B), 30) in which the nibs 2810A, 2810B are longitudinally offset from the spring arms 2870A, 2870B, and thus do not apply force to the spring arms 2870A, 2870B when the lever 2808A, 2808B is rotated.

FIG. 32 illustrates the spring 2872 of the connector 2800, alongside a spring 3272 that may find use with the connectors 100, 500, 900, 1200, 1600, 2000, 2400. The spring 3272 may operate according to principles of known lever connectors. In contrast, as noted above, the spring 2872 of the connector 2800 includes two arms 2870 that extend longitudinally from a main portion 2874, where the main portion 2874 forms a clamping site with a bus bar 2876. In some embodiments, the arms 2870 may be parallel with each other and with a conductor insertion direction. In some embodiments, the arms 2870 may extend longitudinally rearward (i.e., away from the conductor insertion opening and towards the cap) from the main portion.

FIGS. 33A-34 illustrate an example locking lever connector 3300 that includes similar features to the connector 100 except as described below. The lever connector 3300 includes a lock member 3310 in the form of a rotating lateral lock bar. The lock member 3310 may include a lateral bar 3344 that extends across the entire width of the connector body 3302 when in the locked position (FIGS. 33C, 34). The lateral bar 3344 may include one or more downward protrusions 3346 that extend into a housing recess 3370 and over a respective support arm 3372 of each lever 108A, 108B when in the locked position. The lateral bar 3344 may be hingedly coupled with the cap 3306, such that the lock member 3310 rotates about a rotation axis that extends laterally through the cap 3306. The rotation axis of the lock member 3310 may be generally parallel with an axis of rotation of the levers 108A, 108B and generally perpendicular to the conductor insertion direction.

The downward protrusions 3346, in the locked position may extend downward beyond an upper surface 3374 of each lever 108A, 108B (see FIG. 34). Each downward protrusion 3346 may have a front vertical face 3376 that abuts a rear vertical face 3378 of the support arm 3372 of the lever 108A, 108B. This abutment may prevent upward movement of the lever 108A, 108B.

In a first aspect of the present disclosure, a lever connector for electrically coupling a plurality of conductors is provided. The lever connector includes a connector body formed of an insulating material and defining a plurality of conductor insertion openings extending along a conductor insertion direction, a plurality of levers, each lever pivotably coupled to the connector body and movable between an open position and a closed position to actuate a corresponding clamping site for clamping a conductor inserted through a respective conductor insertion opening, and a lock member movably coupled to the connector body and configured to move between a locked position and an unlocked position, wherein, in the locked position, the lock member prevents the levers from moving to open the clamping connections, and in the unlocked position, the lock member permits the levers to move to open the clamping connections.

In an embodiment of the first aspect, the lock member is coupled to the connector body so as to slide between the locked position and the unlocked position along the conductor insertion direction. In a further embodiment of the first aspect, the conductor insertion openings are defined at a front of the connector body and the lock member slides rearward to the locked position and forward to the unlocked position. In a further embodiment of the first aspect, the lock member includes one or more protrusions that engage one or more apertures defined by the levers to secure the levers in the locked position. In a further embodiment of the first aspect, the conductor insertion openings are defined at a front of the connector body and the lock member slides forward to the locked position and rearward to the unlocked position. In a further embodiment of the first aspect, the lock member covers at least a portion of an upper surface of a user-actuatable portion of each lever in the locked position. In a further embodiment of the first aspect, the lock member or the connector body defines a longitudinal channel and the other of the lock member or the connector body defines a lateral protrusion, wherein the lateral protrusion slides within the longitudinal channel.

In an embodiment of the first aspect, the lock member is coupled to the connector body so as to rotate between the locked position and the unlocked position. In a further embodiment of the first aspect, the conductor insertion openings are defined at a front of the connector body, and the lock member is rotatably coupled to a back of the connector body. In a further embodiment of the first aspect, one of the lock member and the connector body defines a plurality of lateral pins and the other of the lock member and the connector body defines a plurality of lateral apertures that receive respective ones of the lateral pins, wherein the pins define an axis of rotation of the lock member. In a further embodiment of the first aspect, the lock member is coupled to the connector body via a living hinge that defines an axis of rotation of the lock member. In a further embodiment of the first aspect, the lock member covers at least a portion of an upper surface of a user-actuatable portion of each lever in the locked position. In a further embodiment of the first aspect, the lock member covers at least a portion of a rear portion of each lever in the locked position. In a further embodiment of the first aspect, the lock member clips to a lateral side of the connector body in the locked position. In a further embodiment of the first aspect, the lock member is lifted away from the connector body to move from the locked position to the unlocked position. In a further embodiment of the first aspect, the lock member is pressed into the connector body to move from the locked position to the unlocked position.

In a second aspect of the present disclosure, a lever connector for electrically coupling a plurality of conductors is provided. The lever connector includes a connector body formed of an insulating material and defining a plurality of conductor insertion openings extending along a conductor insertion direction, a plurality of levers, each lever pivotably coupled to the connector body and movable between an open position and a closed position to actuate a corresponding clamping site for clamping a conductor inserted through a respective conductor insertion opening, a lock member coupled to the connector body and configured to slide relative to the connector body between a locked position and an unlocked position, wherein, in the locked position, the lock member prevents the levers from moving to open the clamping connections, and in the unlocked position, the lock member permits the levers to move to open the clamping connections.

In an embodiment of the second aspect, the lock member slides along lateral sides of the connector body.

In a third aspect of the present disclosure, a lever connector for electrically coupling a plurality of conductors Is provided. The lever connector includes a connector body formed of an insulating material and defining a plurality of conductor insertion openings extending along a conductor insertion direction, a plurality of levers, each lever pivotably coupled to the connector body and movable between an open position and a closed position to actuate a corresponding clamping site for clamping a conductor inserted through a respective conductor insertion opening, a lock member coupled to the connector body and configured to rotate relative to the connector body between a locked position and an unlocked position, wherein, in the locked position, the lock member prevents the levers from moving to open the clamping connections, and in the unlocked position, the lock member permits the levers to move to open the clamping connections.

In an embodiment of the third aspect, an axis of rotation of the lock member is parallel to a respective axis of rotation of each of the levers.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. A lever connector for electrically coupling a plurality of conductors, comprising:
a connector body formed of an insulating material and defining a plurality of conductor insertion openings extending along a conductor insertion direction;
a plurality of levers, each lever pivotably coupled to the connector body and movable between an open position and a closed position to actuate a corresponding clamping site for clamping a conductor inserted through a respective conductor insertion opening;
a lock member movably coupled to the connector body and configured to move between a locked position and an unlocked position, wherein:
in the locked position, the lock member prevents the levers from moving to open the clamping connections; and
in the unlocked position, the lock member permits the levers to move to open the clamping connections.

2. The lever connector of claim 1, wherein the lock member is coupled to the connector body so as to slide between the locked position and the unlocked position along the conductor insertion direction.

3. The lever connector of claim 2, wherein the conductor insertion openings are defined at a front of the connector body and the lock member slides rearward to the locked position and forward to the unlocked position.

4. The lever connector of claim 3, wherein the lock member comprises one or more protrusions that engage one or more apertures defined by the levers to secure the levers in the locked position.

5. The lever connector of claim 2, wherein the conductor insertion openings are defined at a front of the connector body and the lock member slides forward to the locked position and rearward to the unlocked position.

6. The lever connector of claim 5, wherein the lock member covers at least a portion of an upper surface of a user-actuatable portion of each lever in the locked position.

7. The lever connector of claim 2, wherein the lock member or the connector body defines a longitudinal channel and the other of the lock member or the connector body defines a lateral protrusion, wherein the lateral protrusion slides within the longitudinal channel.

8. The lever connector of claim 1, wherein the lock member is coupled to the connector body so as to rotate between the locked position and the unlocked position.

9. The lever connector of claim 8, wherein:
the conductor insertion openings are defined at a front of the connector body; and
the lock member is rotatably coupled to a back of the connector body.

10. The lever connector of claim 8, wherein one of the lock member and the connector body defines a plurality of lateral pins and the other of the lock member and the connector body defines a plurality of lateral apertures that receive respective ones of the lateral pins, wherein the pins define an axis of rotation of the lock member.

11. The lever connector of claim 8, wherein the lock member is coupled to the connector body via a living hinge that defines an axis of rotation of the lock member.

12. The lever connector of claim 8, wherein the lock member covers at least a portion of an upper surface of a user-actuatable portion of each lever in the locked position.

13. The lever connector of claim 8, wherein the lock member covers at least a portion of a rear portion of each lever in the locked position.

14. The lever connector of claim 8, wherein the lock member clips to a lateral side of the connector body in the locked position.

15. The lever connector of claim 8, wherein the lock member is lifted away from the connector body to move from the locked position to the unlocked position.

16. The lever connector of claim 8, wherein the lock member is pressed into the connector body to move from the locked position to the unlocked position.

17. A lever connector for electrically coupling a plurality of conductors, comprising:
a connector body formed of an insulating material and defining a plurality of conductor insertion openings extending along a conductor insertion direction;
a plurality of levers, each lever pivotably coupled to the connector body and movable between an open position and a closed position to actuate a corresponding clamping site for clamping a conductor inserted through a respective conductor insertion opening;
a lock member coupled to the connector body and configured to slide relative to the connector body between a locked position and an unlocked position, wherein:
in the locked position, the lock member prevents the levers from moving to open the clamping connections; and
in the unlocked position, the lock member permits the levers to move to open the clamping connections.

18. The lever connector of claim 17, wherein the lock member slides along lateral sides of the connector body.

19. A lever connector for electrically coupling a plurality of conductors, comprising:
a connector body formed of an insulating material and defining a plurality of conductor insertion openings extending along a conductor insertion direction;
a plurality of levers, each lever pivotably coupled to the connector body and movable between an open position and a closed position to actuate a corresponding clamping site for clamping a conductor inserted through a respective conductor insertion opening;
a lock member coupled to the connector body and configured to rotate relative to the connector body between a locked position and an unlocked position, wherein:
in the locked position, the lock member prevents the levers from moving to open the clamping connections; and
in the unlocked position, the lock member permits the levers to move to open the clamping connections.

20. The lever connector of claim 19, wherein an axis of rotation of the lock member is parallel to a respective axis of rotation of each of the levers.
